(19) United States
(12) Patent Application Publication
(10) Pub. No.: US 2014/0201368 A1
(43) Pub. Date: Jul. 17, 2014

(54) METHOD AND APPARATUS FOR ENFORCING BEHAVIOR OF DASH OR OTHER CLIENTS

(71) Applicant: Samsung Electronics Co., Ltd., Suwon-si (KR)

(72) Inventors: Imed Bouazizi, Plano, TX (US); Mark Edward Trayer, Allen, TX (US); Kong Posh Bhat, Plano, TX (US); Zhu Li, Plano, TX (US); Youngkwon Lim, Allen, TX (US)

(73) Assignee: Samsung Electronics Co., Ltd., Suwon-si (KR)

(21) Appl. No.: 14/153,803

(22) Filed: Jan. 13, 2014

Related U.S. Application Data
(60) Provisional application No. 61/838,778, filed on Jun. 24, 2013.
(60) Provisional application No. 61/752,811, filed on Jan. 15, 2013.

(51) Int. Cl. H04L 29/08

(52) U.S. Cl. CPC H04L 67/02
USPC 709/225

(57) ABSTRACT

A method for obtaining content includes determining that a playout of one or more other pieces of content is dependent upon a playout of a first piece of content. The method also includes obtaining the first piece of content and identifying a forced content token associated with the first piece of content. The method further includes obtaining an access token using the forced content token. In addition, the method includes using the access token to obtain the one or more other pieces of content. The forced content token could be identified as a hash of the first piece of content or as a watermark extracted from the first piece of content. The forced content token could also be identified by creating a thumbnail for each of one or more frames in the first piece of content and calculating a differential trace signature for each of the one or more frames.

### CROSS-REFERENCE TO RELATED APPLICATION AND CLAIM OF PRIORITY

This application claims priority under 35 U.S.C. §119(e) to U.S. Provisional Patent Application Ser. No. 61/838,778 filed on Jun. 24, 2013 entitled “Method and Apparatus for Video Segment Playback Verification,” and U.S. Provisional Patent Application Ser. No. 61/752,811 filed on Jan. 15, 2013 entitled “Method and Apparatus for Enforcing Behavior of DASH Client.” The above-identified patent applications are hereby incorporated by reference in their entirety.

### TECHNICAL FIELD

This disclosure relates generally to obtaining content and more specifically to a method and apparatus for enforcing behavior of Dynamic Adaptive HTTP Streaming (DASH) or other clients.

### BACKGROUND

Traditionally, the Transmission Control Protocol (TCP) has been considered as unsuitable for the delivery of real-time media, such as audio and video content. This is mainly due to the aggressive congestion control algorithm and the retransmission procedure that TCP implements. In TCP, the sender reduces the transmission rate significantly (typically by half) upon detection of a congestion event, typically recognized through packet loss or excessive transmission delays. As a consequence, the transmission throughput of TCP is usually characterized by a well-known saw-tooth shape. This behavior is detrimental for streaming applications as they are delay-sensitive but relatively loss-tolerant, whereas TCP sacrifices delivery delay in favor of reliable and congestion-aware transmission.

Recently, the trend has shifted towards the deployment of Hypertext Transport Protocol (HTTP) as the preferred protocol for the delivery of multimedia content over the Internet. HTTP runs on top of TCP and is a textual protocol. The reason for this shift is attributable to the ease of deployment of the protocol. There is no need to deploy a dedicated server for delivering content. Furthermore, HTTP is typically granted access through firewalls and Network Address Translation (NAT) devices, which significantly simplifies deployment.

Dynamic Adaptive HTTP Streaming (DASH) has been standardized recently by the 3^{rd} Generation Partnership Project (3GPP) and Motion Pictures Expert Group (MPEG). Several other proprietary solutions for adaptive HTTP streaming, such as APPLE's HTTP Live Streaming (HLS) and MICROSOFT's Smooth Streaming, are being commercially deployed. Unlike those, however, DASH is a fully-open and standardized media streaming solution, which drives inter-operability among different implementations.

### SUMMARY

In a first embodiment, a method for obtaining content includes determining that a playout of one or more other pieces of content is dependent upon a playout of a first piece of content. The method also includes obtaining the first piece of content and identifying a forced content token associated with the first piece of content. The method further includes obtaining an access token using the forced content token. In addition, the method includes using the access token to obtain the one or more other pieces of content.

In a second embodiment, an apparatus configured to obtain content over a network includes at least one memory configured to store a first piece of content and one or more other pieces of content. The apparatus also includes at least one processing device configured to determine that a playout of the one or more other pieces of content is dependent upon a playout of the first piece of content. The at least one processing device is also configured to obtain the first piece of content and identify a forced content token associated with the first piece of content. The at least one processing device is further configured to obtain an access token using the forced content token and use the access token to obtain the one or more other pieces of content.

In a third embodiment, a non-transitory computer readable medium embodies a computer program. The computer program includes computer readable program code for determining that a playout of one or more other pieces of content is dependent upon a playout of a first piece of content. The computer program also includes computer readable program code for obtaining the first piece of content and for identifying a forced content token associated with the first piece of content. The computer program further includes computer readable program code for obtaining an access token using the forced content token and for using the access token to obtain the one or more other pieces of content.

Before undertaking the DETAILED DESCRIPTION below, it may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software/firmware. It should be noted that the functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document, and those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example client device according to this disclosure;

FIG. 2 illustrates an example networked system for streaming multimedia content according to this disclosure;

FIG. 3 illustrates an example adaptive Hypertext Transmission Protocol (HTTP) streaming (AHS) architecture according to this disclosure;

FIG. 4 illustrates an example structure of a Media Presentation Description (MPD) file according to this disclosure;

FIG. 5 illustrates an example structure of a fragmented International Standards Organization (ISO)-base file format (ISOFF) media file according to this disclosure;

FIG. 6 illustrates an example timeline with forced playout content and main content according to this disclosure;

FIGS. 7 through 9 illustrate example methods for retrieving content according to this disclosure;

FIG. 10 illustrates an example chart of thumbnail appearance model Eigen values according to this disclosure;

FIGS. 11A through 11C illustrate example forced playout content sequences according to this disclosure;

FIG. 12 illustrates example charts of thumbnail Eigen appearance basis functions according to this disclosure;

FIGS. 13A and 13B illustrate an example chart of thumbnail Eigen appearance basis functions and an example chart of false positive rates according to this disclosure; and

FIG. 14 illustrates another example method for retrieving content according to this disclosure.

### DETAILED DESCRIPTION

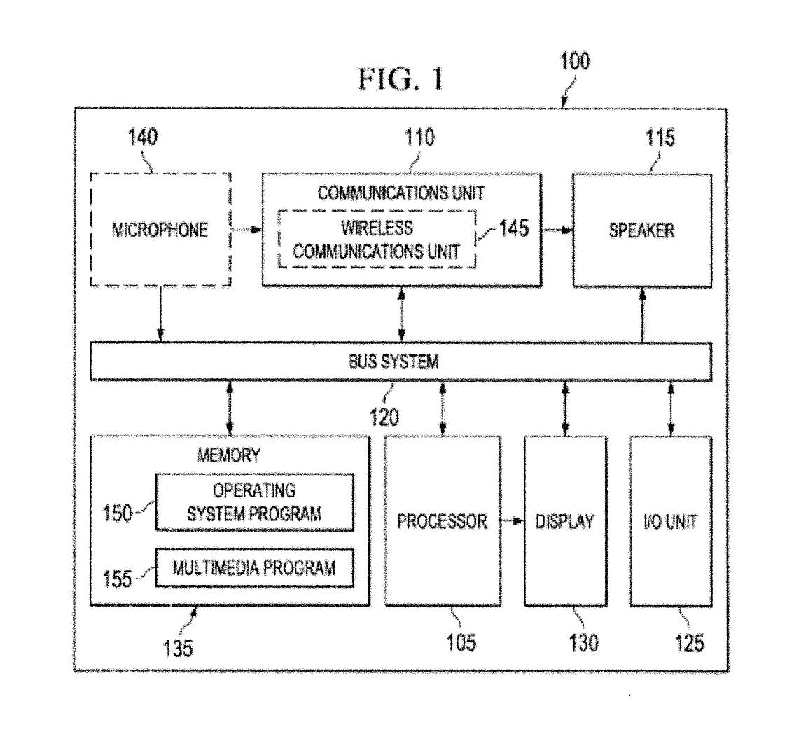

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged method and apparatus.

For convenience of description, the following terms and phrases used in this patent document are defined.

Dynamic Adaptive Streaming over HTTP (DASH)—A typical scheme of adaptive streaming, which changes server-controlled adaptive streaming to client-controlled adaptive streaming. In server-controlled adaptive streaming, a server has information about its connections to all connected clients and generates what each client requires, thereby transmitting optimal content for each network situation. Disadvantageously, however, the server may be overloaded as the clients increase in number. In DASH, the server generates media segments and metadata in advance for several possible cases, and the clients request and play content depending on the situation. This makes it possible to download and play the optimal content depending on the network conditions while reducing the load placed on the server.

Content—Examples of content include audio information, video information, audio-video information, and data. Content items may include a plurality of components as described below.

Components—Refers to components of a content item, such as audio information, video information, and subtitle information. For example, a component may be a subtitle stream composed in a particular language or a video stream obtained at a certain camera angle. The component may be referred to as a track or an Elementary Stream (ES) depending on its container.

Content Resources—Refer to content items (such as various qualities, bit rates, and angles) that are provided in a plurality of representations to enable adaptive streaming for content items. A service discovery process may be referred to as content resources. The content resources may include one or more consecutive time periods.

Period—Refers to a temporal section of content resources.

Representations—Refer to versions (for all or some components) of content resources in a period. Representations may be different in a subset of components or in encoding parameters (such as bit rate) for components. Although representations are referred to here as media data, they may be referred to as any terms indicating data, including one or more components, without being limited thereto.

Segment—Refers to a temporal section of representations, which is named by a unique Uniform Resource Locator (URL) in a particular system layer type (such as Transport Stream (TS) or Moving Picture Experts Group (MPEG)-4 (MP4) Part 14).

FIG. 1 illustrates an example client device 100 according to this disclosure. In this example, the client device 100 is a device for generating and/or receiving anchored location information about multimedia content streamed over a network. The client device 100 represents any suitable fixed or portable device for receiving content. For example, the client device 100 may represent a mobile telephone or smartphone, a laptop computer, a desktop computer, a tablet computer, a media player, an audio player (such as an MP3 player or radio), a television, or any other device suitable for receiving streamed contents.

In this example, the client device 100 includes a processor 105, a communications unit 110, a speaker 115, a bus system 120, an input/output (I/O) unit 125, a display 130, and a memory 135. The client device 100 may also include a microphone 140, and the communications unit 110 could include a wireless communications unit 145. The memory 135 includes an operating system (OS) program 150 and at least one multimedia program 155.

The communications unit 110 provides for communications with other systems or devices over a network. For example, the communications unit 110 could include a network interface card or a wireless transceiver. The communications unit 110 may provide communications through wired, optical, wireless, or other communication links to a network.

In some embodiments, the client device 100 is capable of receiving information over a wireless network. For example, the communications unit 110 here includes the wireless communications unit 145. The wireless communications unit 145 may include an antenna, radio frequency (RF) transceiver, and processing circuitry. The RF transceiver may receive via the antenna an incoming RF signal transmitted by a base station, eNodeB, or access point of a wireless network. The RF transceiver down-converts the incoming RF signal to produce an intermediate frequency (IF) or baseband signal. The IF or baseband signal is sent to receiver (RX) processing circuitry, which produces a processed baseband signal by filtering, digitizing, demodulation, and/or decoding operations. The RX processing circuitry transmits the processed baseband signal to the speaker 115 (such as for audio data) or to the processor 105 for further processing (such as for video data and audio data processing).

The wireless communications unit 145 may also include transmitter (TX) processing circuitry that receives analog or digital voice data from the microphone 140 or other outgoing baseband data (such as web data, e-mail, or generated location information) from the processor 105. The transmitter processing circuitry can encode, modulate, multiplex, and/or digitize the outgoing baseband data to produce a processed baseband or IF signal. The RF transceiver can receive the outgoing baseband or IF signal from the transmitter processing circuitry and up-convert the baseband or IF signal to an RF signal that is transmitted via the antenna.

The processor 105 processes instructions that may be loaded into the memory 135. The processor 105 may include a number of processors, a multi-processor core, or some other type(s) of processing device(s) depending on the particular implementation. In some embodiments, the processor 105 may be or include one or more graphics processors for processing and rendering graphical and/or video data for presentation by the display 130. In particular embodiments, the processor 105 is a microprocessor or microcontroller. The memory 135 is coupled to the processor 105. Part of the memory 135 could include a random access memory (RAM), and another part of the memory 135 could include a non-volatile memory such as a Flash memory, an optical disk, a rewritable magnetic tape, or any other type of persistent storage.

The processor 105 executes the OS program 150 stored in the memory 135 in order to control the overall operation of the client device 100. In some embodiments, the processor 105 controls the reception of forward channel signals and the transmission of reverse channel signals by the wireless communications unit 145 in accordance with well-known principles.

The processor 105 is capable of executing other processes and programs resident in the memory 135, such as the multimedia program 155. The processor 105 can move data into or out of the memory 135 as required by an executing process. The processor 105 is also coupled to the I/O interface 125. The I/O interface 125 allows for input and output of data using other devices that may be connected to the client device 100. For example, the I/O unit 125 may provide a connection for user input through a keyboard, a mouse, or other suitable input device. The I/O unit 125 may also send output to a display, printer, or other suitable output device.

The display 130 provides a mechanism to visually present information to a user. The display 130 may be a liquid crystal display (LCD) or other display capable of rendering text and/or graphics. The display 130 may also be one or more display lights indicating information to a user. In some embodiments, the display 130 is a touch screen that allows user inputs to be received by the client device 100.

The multimedia program 155 is stored in the memory 135 and executable by the processor 105. The multimedia program 155 is a program for calculating and extracting forced playout tokens, which is described in greater detail below.

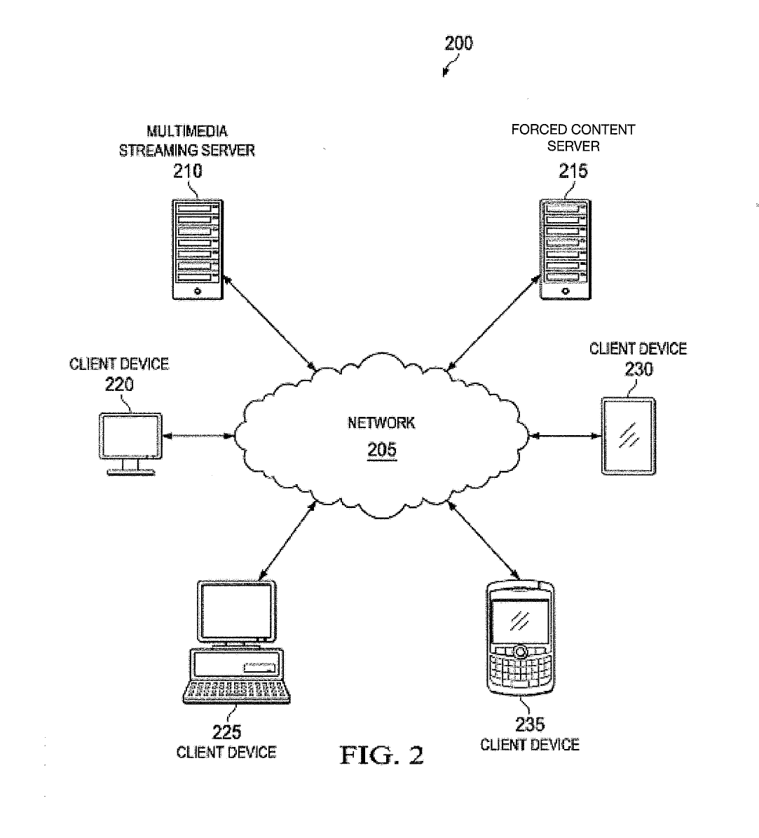

FIG. 2 illustrates an example networked system 200 for streaming multimedia content according to this disclosure. As shown in FIG. 2, the system 200 includes a network 205, which provides communication links between various computers and other devices. The network 205 may include any suitable connections, such as wired, wireless, or fiber optic links. In some embodiments, the network 205 represents at least a portion of the Internet and can include a worldwide collection of networks and gateways that use the Transmission Control Protocol/Internet Protocol (TCP/IP) suite of protocols to communicate with one another. However, any other public and/or private network(s) could be used in the system 200. Of course, the system 200 may be implemented using a number of different types of networks, such as an intranet, a local area network (LAN), a wide area network (WAN), or a cloud computing network.

Server computers 210-215 and client devices 220-235 connect to the network 205. Each of the client devices 220-235 may, for example, represent the client device 100 in FIG. 1. The client devices 220-235 are clients to the server computers 210-215 in this example. The system 200 may include additional server computers, client devices, or other devices. In this example, the server 210 represents a multimedia streaming server, while the server 215 represents a forced playout content server that can play forced content, such as advertisements.

In some embodiments, the network 205 includes a wireless network of base stations, eNodeBs, access points, or other components that provide wireless broadband access to the network 205 and the client devices 220-235 within a wireless coverage area. In particular embodiments, base stations or eNodeBs in the network 205 may communicate with each other and with the client devices 220-235 using orthogonal frequency-division multiplexing (OFDM) or OFDM access (OFDMA) techniques.

In this example, the client devices 220-235 receive streamed multimedia content from the multimedia streaming server 210. In some embodiments, the client devices 220-235 receive the multimedia content using DASH. In other embodiments, the client devices 220-235 may receive multimedia content using the real-time streaming protocol (RTSP), the real-time transport protocol (RTP), the HTTP adaptive streaming (HAS) protocol, the HTTP live streaming (HLS) protocol, smooth streaming, and/or other type of standard for streaming content over a network.

Note that the illustrations of the client device 100 in FIG. 1 and the networked system 200 in FIG. 2 are not meant to imply physical or architectural limitations on the manner in which this disclosure may be implemented. Various components in each figure could be combined, further subdivided, or omitted and additional components could be added according to particular needs. Also, client devices and networks can come in a wide variety of forms and configurations, and FIGS. 1 and 2 do not limit the scope of this disclosure to any particular implementation.

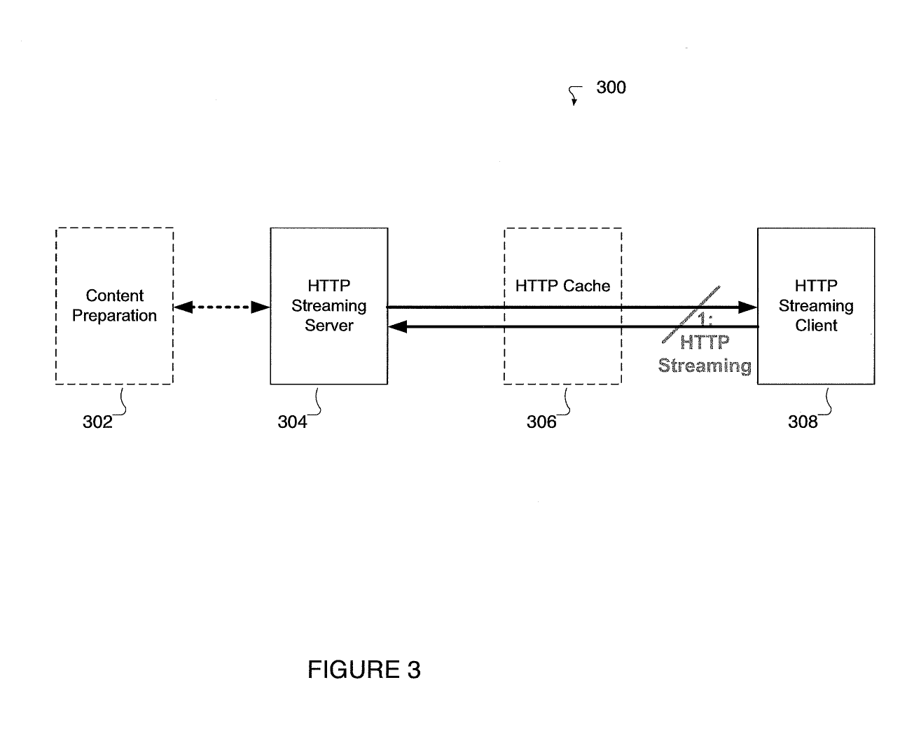

FIG. 3 illustrates an example adaptive Hypertext Transmission Protocol (HTTP) streaming (AHS) architecture 300 according to this disclosure. As shown in FIG. 3, the architecture 300 includes a content preparation module 302, an HTTP streaming server 304, an HTTP cache 306, and an HTTP streaming client 306. In some embodiments, the architecture 300 may be implemented in the networked system 200.

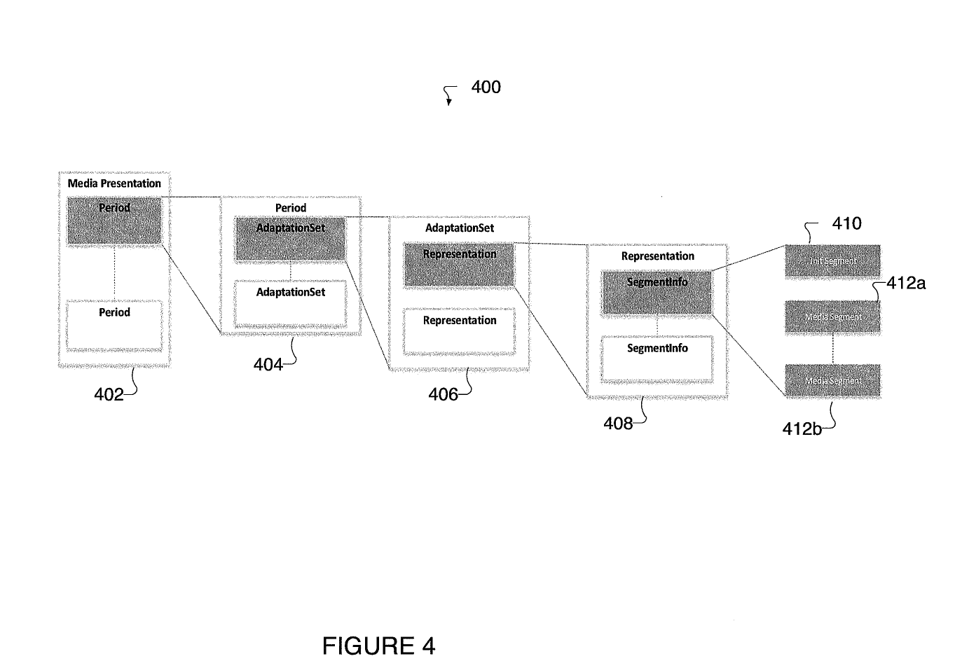

FIG. 4 illustrates an example structure of a Media Presentation Description (MPD) file 400 according to this disclosure. As shown in FIG. 4, the MPD file 400 includes a media presentation 402, a period 404, an adaptation set 406, a representation 408, an initial segment 410, and media segments 412a-412b. In some embodiments, the MPD file 400 may be implemented in the networked system 200.

Referring to FIGS. 3 and 4, in the DASH protocol, a content preparation step may be performed in which content is segmented into multiple segments. The content preparation module 302 may perform this content preparation. Also, an initialization segment may be created to carry information used to configure a media player. The information allows the media segments to be consumed by a client device. The content may be encoded in multiple variants, such as several bitrates. Each variant corresponds to a representation 408 of the content. The representations 408 may be alternative to each other or may complement each other. In the former case, the client device selects only one alternative out of the group of alternative representations 408. Alternative representations 408 are grouped together as an adaptation set 406. The client device may continue to add complementary representations that contain additional media components.

The content offered for DASH streaming may be described to the client device. This may be done using the MPD file 400. The MPD file 400 is an eXtensible Markup Language (XML) file that contains a description of the content, the periods of the content, the adaptation sets, the representations of the content, and how to access each piece of the content. An MPD element is the main element in the MPD file, as it contains general information about the content, such as its type and the time window during which the content is available. The MPD file 400 also contains one or more periods 404, each of which describes a time segment of the content. Each period 404 may contain one or more representations 408 of the content grouped into one or more adaptation sets 406. Each representation 408 is an encoding of one or more content components with a specific configuration. Representations 408 differ mainly in their bandwidth requirements, the media components they contain, the codecs in use, the languages, or the like.

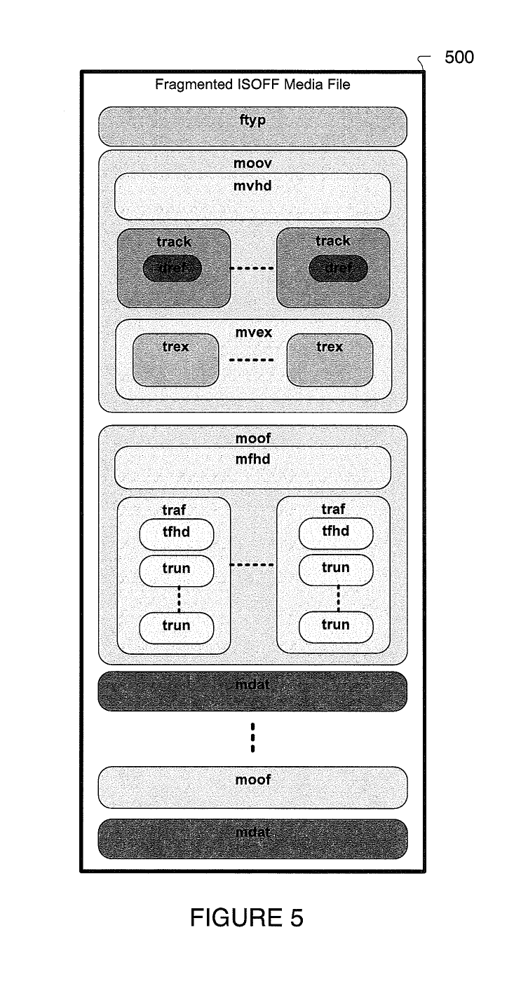

FIG. 5 illustrates an example structure of a fragmented International Standards Organization (ISO)-base file format (ISOFF) media file 500 according to this disclosure. In some embodiments, the ISOFF media file 500 may be implemented in the networked system 200. In one deployment scenario of DASH, the ISO-base file format and its derivatives (such as the MP4 and 3GP file formats) are used. The content is stored in so-called movie fragments. Each movie fragment contains media data and the corresponding metadata. The media data is typically a collection of media samples from all media components of the representation. Each media component is described as a track of the file.

In DASH, the client device is fully responsible for the media session and controls the rate adaptation by deciding on which representation to consume at any particular time. DASH is thus a client-driven media streaming solution.

Online video advertisements are gaining importance due to the fast growth of online video consumption. A large portion of advertising budgets is now going to online video. For example, in return for watching free content on the Internet, a user may be forced to watch a short advertisement. The advertisement may be inserted at the start (pre-roll), towards the beginning, or towards the end (post-roll) of the original content. While a mid-roll option is very popular in traditional linear television broadcasts, pre-roll has been very popular in online video. The business model of sponsoring online video through online video advertisements has established itself in the media distribution industry. Advertisements are often typically 15 second spots and thus much shorter than classic television advertisements.

In accordance with this disclosure, various methods and devices are disclosed for enforcing client playout behavior on client devices that have open implementations, such as DASH clients. A content description describes the content for which playout is to be forced. It also describes the dependency between the forced content and the original content. Additionally, it describes the type and position in a timeline of the forced playout. This information is used by the client device to identify the forced playout behavior. In some embodiments, the presence of forced content playout is signaled as part of the MPD. The information may contain the position in the timeline at which the forced content is to be played. It may also contain the relationship to other pieces of the main content. For instance, the forced playout content may be defined as a separate period 404, and the content of the following period 404 may be declared as dependent on it. In addition, the information may indicate a type of the forced content token, a forced content verification server URL, and time constraints for using the content access token.

The following XML schema fragment shows a possible implementation of the signaling as part of the MPD:

<?xml version=“1.0” encoding=“UTF-8”?>
<xs:schema xmlns:xs=“http://www.w3.org/2001/XMLSchema”
elementFormDefault=“qualified” attributeFormDefault=“unqualified”>

<xs:complexType name=“ForcedPlayoutType”>

<xs:sequence>

<xs:element name=“ForcedContentVerificationServer”
type=“xs:url”

minOccurs=“1”/>

</xs:sequence>
<xs:attribute name=“forcedContentToken”
type=“ForcedContentTokenType”

use=“optional” default=“MD5”/>

<xs:attribute name=“accessTokenValidityStart”
type=“xs:dateTime”

use=“optional”/>

<xs:attribute name=“accessTokenValidityEnd”
type=“xs:dateTime”

use=“optional”/>

<xs:attribute name=“accessTokenValidityStartOffset”
type=“xs:duration”

use=“optional”/>

<xs:attribute name=“accessTokenValidityDuration”
type=“xs:duration”

use=“optional”/>

</xs:complexType>
<xs:simpleType name=“ForcedContentTokenType”>

<xs:restriction base=“xs:string”>

<xs:enumeration value=“MD5”/>
<xs:enumeration value=“Watermark”/>
<xs:enumeration value=“EmbeddedToken”/>

</xs:restriction>

</xs:simpleType>
<xs:complexType name=“PlayoutDependencyType”>

<xs:sequence>
</xs:sequence>
<xs:attribute name=“referencePeriodID” type=“xs:string”/>
<xs:attribute name=“type” type=“AccessMethodType”/>

</xs:complexType>
<xs:simpleType name=“AccessMethodType”>

<xs:restriction base=“xs:string”>

<xs:enumeration value=“BaseURLParameter”/>
<xs:enumeration value=“TemplateParameter”/>
<xs:enumeration value=“HTTPAuthentication”/>

</xs:restriction>

</xs:simpleType>

</xs:schema>

Based on the previous possible XML schema implementation, the following XML fragment shows a potential implementation in the MPD:

<Period id=“AdPeriod” start=“PT15M” duration=“PT15.00S”>

<ForcedPlayout forcedContentToken=“MD5” accessTokenValitdityStartOffset=“PT10S”

accessTokenValidityDuration=“PT1H”>

<ForcedCotnentVerificationServer>http://www.example.com/verifyForcedContent.php<

/ForcedCotnentVerificationServer>

</ForcedPlayout>
<AdaptationSet mimeType=“video/mp4” codecs=“avc1.640828”>

<Representation id=“Ad1” bandwidth=“256000”>

<SegmentList duration=“15”>

<SegmentURL media=“ad1.mp4”/>

</SegmentList>

</Representation>

</AdaptationSet>

</Period>
<Period start=“PT0.00S” duration=“PT2000.00S”>

<PlayoutDependency referencePeriodID=“AdPeriod” type=“BaseURLParameter”/>
<BaseURL>http://www.example.com/Content/$AccessToken$/</BaseURL>
<SegmentList>

<Initialization sourceURL=“seg-m-init.mp4”/>

</SegmentList>
<AdaptationSet mimeType=“video/mp4” codecs=“avc1.640828”>

<Role schemeIdUri=“urn:mpeg:dash:stereoid:2011” value=“l1 r0”/>
<Representation id=“C2” bandwidth=“128000”>

<SegmentList duration=“10”>

<SegmentURL media=“seg-m1-C2view-1.mp4”/>
<SegmentURL media=“seg-m1-C2view-2.mp4”/>
<SegmentURL media=“seg-m1-C2view-3.mp4”/>

</SegmentList>

</Representation>

</AdaptationSet>

</Period>

In this example, an obtained access token can be inserted as part of the base URL of the period 404 of which the content depends on (follows) the playout of the forced playout content.

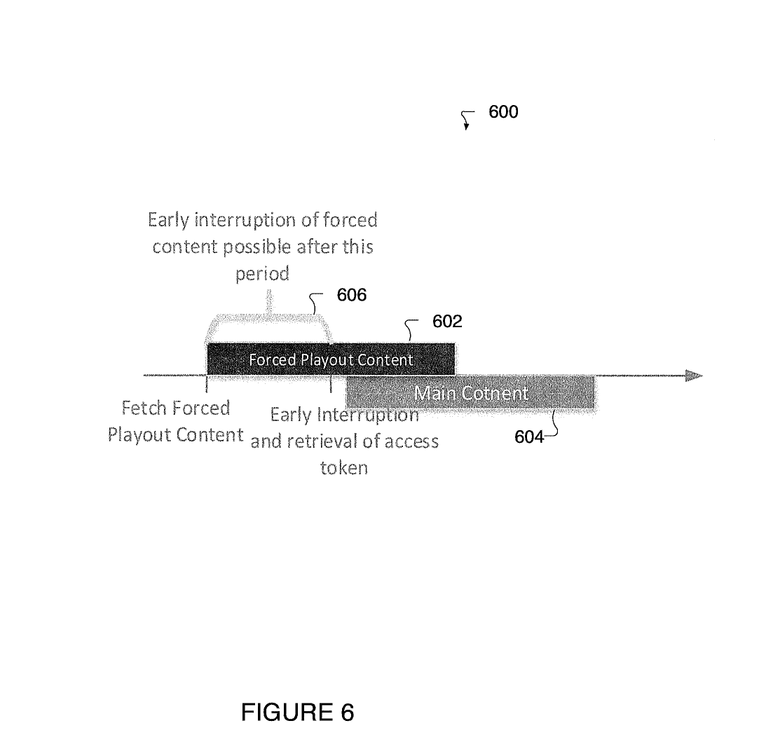

FIG. 6 illustrates an example timeline 600 with forced playout content 602 and main content 604 according to this disclosure. In some embodiments, the timeline 600 may be implemented in the networked system 200. Depending on the implementation, signaling between client and server devices may contain information about options for early interruption of the forced playout content 602. For example, a content provider may allow users to interrupt playback of the forced playout content 602 after a time period 606 defining a specified amount of time has elapsed. By controlling the time period 606 for access tokens to become valid, the content provider is able to implement an early playout interruption option for client devices.

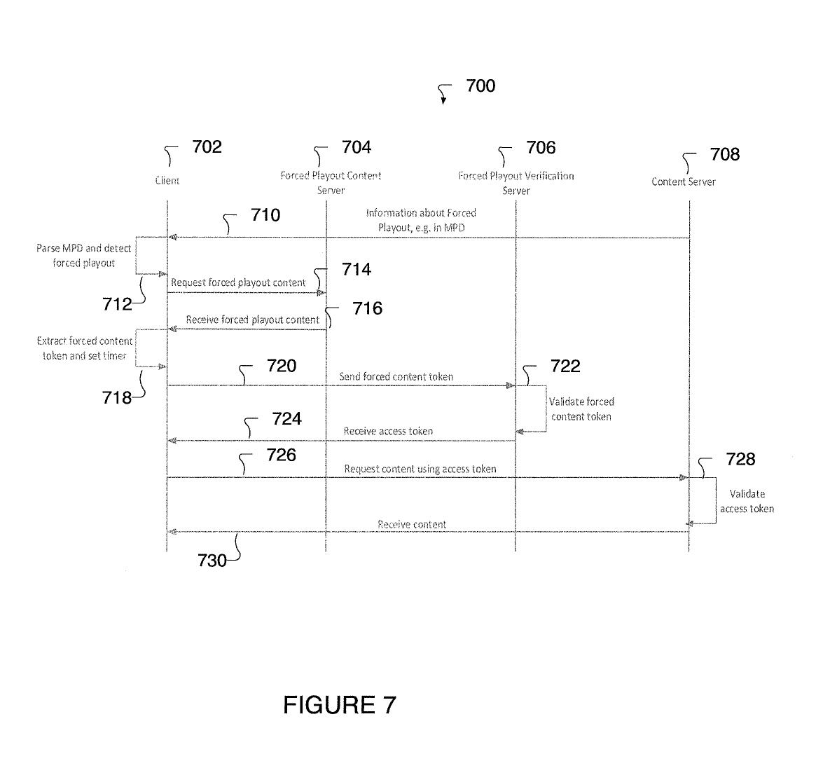

FIGS. 7 through 9 illustrate example methods for retrieving content according to this disclosure. In some embodiments, the methods shown in FIGS. 7 through 9 can be implemented in the networked system 200.

As shown in FIG. 7, a method 700 includes the use of messaging between a client 702, a forced playout content server 704, a forced playout verification server 706, and a content server 708. In some embodiments, the method 700 may be implemented in the networked system 200.

In operation 710, the content server 708 may send the client 702 information about forced playout content. The information may be in an MPD. The client 702 may parse the information and detect forced playout content in operation 712. In operation 714, the client 702 may request the forced playout content from the forced playout content server 704. In operation 716, the forced playout content server 704 sends the forced playout content to the client 702.

In operation 718, the client 702 extracts a forced content token from the forced playout content and sets a timer. In some embodiments, the forced content token is calculated out of the forced content. For instance, an MD5 hash code of one or more segments of the forced content could be calculated and used as a token. If more than one segment is used, a hash code may be calculated over a concatenated set of segments. In other embodiments, the forced content token is embedded as a watermark in the content of which the playout is to be forced.

After extracting/calculating the forced content token, the client 702 uses that token to obtain an access token. In operation 720, the client 702 contacts the forced playout verification server 706 and provides the forced content token. In operation 722, the forced content token is verified by the forced playout verification server 706. In case of a successful verification, in operation 724, the forced playout verification server 706 replies to the client 702 with the access token. Depending on the signaled method, in operation 726, the client 702 uses the access token to request access to the main content that is declared as dependent on the forced playout content from the content server 708. In operation 728, the content server 708 may validate the access token. In operation 730, the content server 708 may send the main content to the client 702.

The different embodiments disclosed in this patent document recognize and take into account that deployment of DASH may not be successful unless a solution is provided for monetizing content through advertisements. DASH is an open standard that allows for interoperability but at the same time enables 3^{rd} party implementations of the DASH client. DASH content providers will fail to enforce playout of advertisements on open clients. This may hamper the deployment of DASH significantly. This solution can be used to provide the missing enabler for a complete media streaming solution.

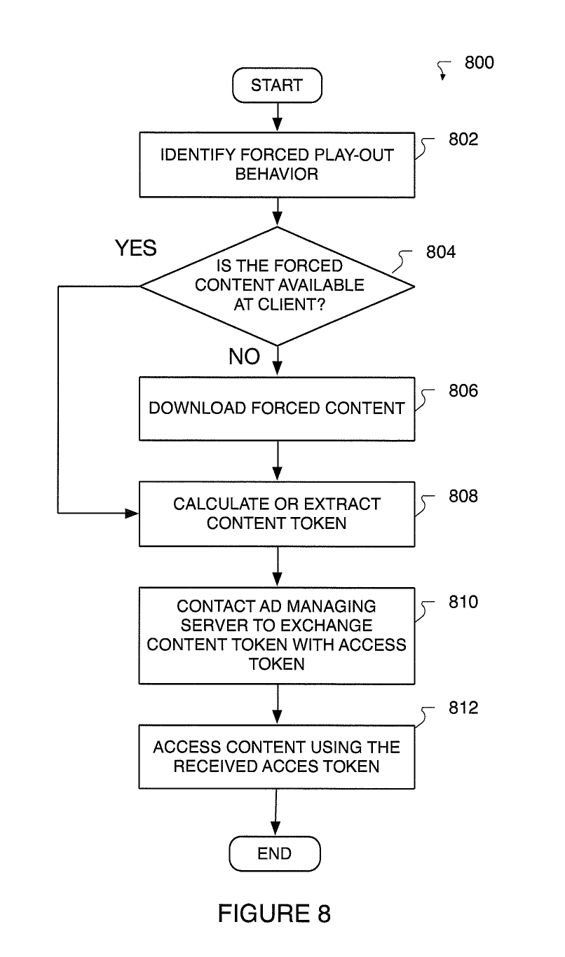

As shown in FIG. 8, a method 800 includes, in operation 802, the client 702 identifying a forced playout behavior. In operation 804, the client 702 identifies whether forced playout content is available at the client 702. If the forced playout content is not already pre-cached at the client 702, at operation 806, the client 702 downloads the forced playout content. Depending on the token type, at operation 808, the client 702 calculates or extracts the forced content token.

In order to access the main content that depends on the playout of the forced content, at operation 810, the client 702 first contacts the forced content (advertisement) managing server to exchange the forced playout content token into an access token. Subsequently, at operation 812, the client 702 uses the received access token to access the main content.

The different embodiments disclosed in this patent document also recognize and take into account that online video advertisements are becoming the main revenue channel for content providers due to the exponential growth in online video consumption. A large portion of advertising budgets is now being allocated to online video. In return for watching free content on the Internet, the user is “forced” to watch a short advertisement. The advertisement may be inserted at the start (pre-roll), in the middle (mid-roll), or towards the end (post-roll) of the original content. While the mid-roll option is very popular in traditional linear TV, pre-roll has become very popular in online video. The advertisements are often typically 15 second spots and thus much shorter than classical advertisements on TV.

The different embodiments disclosed in this patent document further recognize and take into account that the business model of sponsoring online video through online video advertisements has established itself in the media distribution industry. Several players contribute to building this eco-system. Those include content delivery networks (CDNs), analytic data providers, advertisement networks, and advertisement exchange platforms. Impressions are sold via advertisement-exchange platforms, and the selected advertisement is delivered by the CDN. Verification and analytics tools verify the completion rate of the advertisements and report this information to the advertisers.

Moreover, the different embodiments disclosed in this patent document recognize and take into account that DASH defines an open standard for adaptive media streaming over HTTP. DASH uses open standards such as XML, HTTP, and MPEG ISO-Base Media File Format for building the streaming function. Contrary to classical streaming approaches, DASH is client-driven, which means that the client is in full control of the content it receives. The service provider offers to the client a set of variants to choose from and combine in order to optimize the delivery experience. The variants are described in the MPD, which is an XML-formatted document.

Recently, the Web Real-Time Communications Working Group has published an API for web browsers to feed content segments received from multiple media sources to an integrated media player. This API integrates seamlessly with HTML5 media tags and enables the support of DASH and other adaptive media streaming solutions over HTTP.

In addition, the different embodiments disclosed in this patent document recognize and take into account that, as a consequence of these factors, a large variety of client implementations, most of which will be open-source, will be offered to the clients. For instance, websites may offer JavaScript DASH implementations as part of their web pages. Users may also use their own players or modify existing player implementations to play content offered via DASH.

Given these facts, it is difficult to establish a trust relationship between a service provider and a DASH client. This fact jeopardizes the existing online video delivery eco-system, which requires a trusted client to display an advertisement to a viewer at a given time point and for a given period of time.

Ad insertion in DASH may occur in two different ways: (1) advertisement splicing where content is pre-inserted as part of the original media content and (2) advertisements provided separately, such as in a new period 404 in the content. While the former option may offer better reliability, it can limit the flexibility of advertisement insertion, such as advertisement customization and dynamic decision about the advertisement to be inserted. The latter option, however, in the absence of trusted DASH clients will mark pieces of content as advertisements and thus literally invite implementations to bypass those advertisements completely.

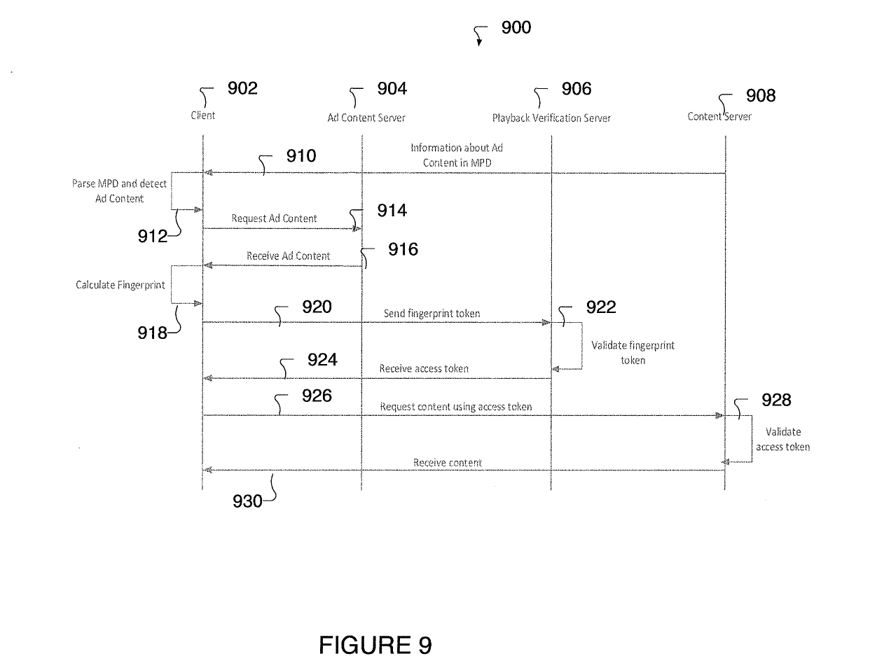

As shown in FIG. 9, a method 900 includes messaging between a client 902, a forced playout content server 904, a forced playout verification server 906, and a content server 908. In an example embodiment, method 900 may be implemented in networked system 200. In some embodiments, the method 900 is similar to the method 700, except that the method 900 uses a fingerprint as verification of playback instead of a hash or watermark.

In some embodiments, to verify an advertisement's playback, a lightweight fingerprint is computed at the client 902. The fingerprint is then verified at the playout verification server 906. Upon successful verification of the fingerprint, the playout verification server 906 will issue a token to the client 902 to request the video segment from the content server 908.

In operation 910, the content server 908 may send the client 902 information about the forced playout content. The information may be in an MPD. The client 902 may parse the information and detect forced playout content in operation 912. In operation 914, the client 902 may request the forced playout content from the forced playout content server 904. In operation 916, the forced playout content server 904 sends the forced playout content to the client 902.

In operation 918, the client 902 calculates a fingerprint for the forced playout content. After calculating the fingerprint token, the client 902 uses that token to obtain an access token. In operation 920, the client 902 contacts the forced playout verification server 906 and provides the fingerprint token. In some embodiments, the fingerprint token may be one example of a forced content token. In operation 922, the fingerprint token is verified by the forced playout verification server 906.

In case of a successful verification, in operation 924, the forced playout verification server 906 replies to the client 902 with an access token. Depending on the signaled method, in operation 926, the client 902 uses the access token to request access to the main content that is declared as dependent on the forced playout content from the content server 908. In operation 928, the content server 908 may validate the access token. In operation 930, the content server 908 may send the main content to the client 902.

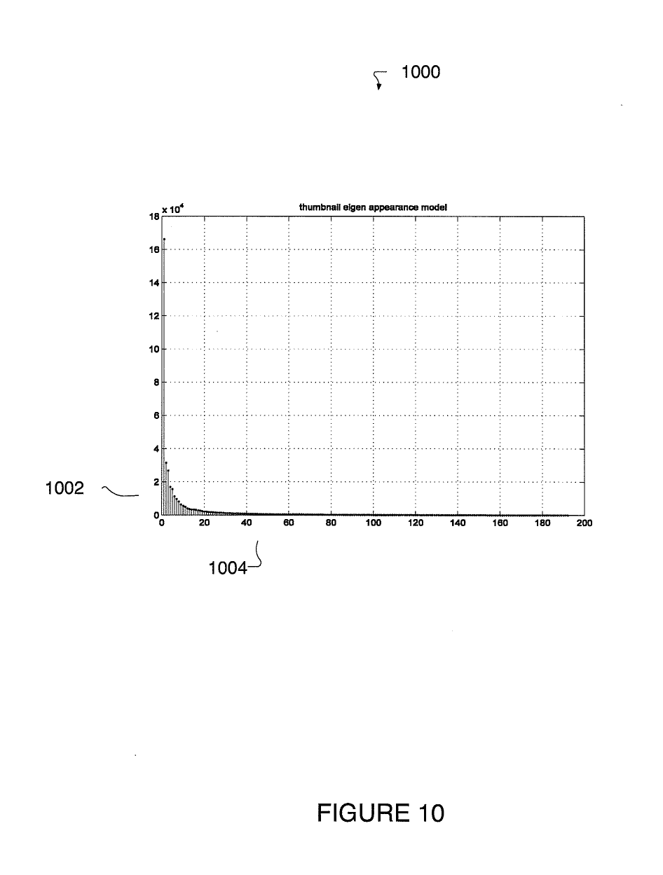

FIG. 10 illustrates an example chart 1000 of thumbnail appearance model Eigen values according to this disclosure. The chart 1000 includes an axis 1002 and an axis 1004. In some embodiments, the chart 1000 may be a chart of data recorded in the networked system 200. In some embodiments, the axis 1002 represents the Eigen values, and the axis 1004 represents the magnitude of the Eigen values.

To have a very lightweight video fingerprint for verification with minimal computing and communication overhead, a one-dimensional signature can be computed for forced playout content. The frames may first be down-sampled to a thumbnail size of w×h pixels, and an offline thumbnail Eigen appearance modeling is performed over a data set {fₖ} in R^{w×h} randomly sampled from a large video repository. The Eigen appearance model of video thumbnails A can be obtained by:

A=max_{A}Σₖ(xₖ−m)′(xₖ−m) (1)

which is solved by principal component analysis (PCA).

In one example, for thumbnail sizes of w=16 and h=12, the Eigen values of PCA are plotted in FIG. 10. As shown here, the thumbnail itself even at the size of 16×12 pixels still has a lot of redundancy inside. By selecting a limited number d of PCA components, the video sequence may be reduced to a low d-dimensional signature as follows:

x=Af (2)

where A is d×(w×h). Here, x is a d-dimensional signature that is used in de-duplication/identification. For the playback verification problem (which is much less demanding than the identification problem in de-duplication), an even more compact signature can be found.

An Eigen appearance differential trace is therefore computed for this purpose. For a video segment of n-frames and its thumbnails {f₁, f₂, . . . , fₙ}, its differential 1-dimensional signature can be computed as:

$$dx ( k ) = \{ \begin{matrix}0 , & if k = 1 \\ A ( {f}_{k + 1} - {f}_{k} ) , & else\end{matrix} \qquad ( 3 )$$

This differential feature is very compact and uses only eight bits per frame to describe, which translates into approximately 240 bps communication overhead for a video sequence frame rate of 30 fps.

In some embodiments, playback verification is therefore performed as follows. On the client side, after a video is decoded, a thumbnail is computed for each frame, and its differential trace signature is computed according to equation (4) below and communicated back to the server for verification. A threshold is tested to determine positive or negative verification of two video sequences and their differential signature, dx¹/and dx², as follows:

$$\{ \begin{matrix}verification successful , if {\sum }_{k} ( {dx}_{k}^{1} - {dx}_{k}^{2} ) > θ \\ else\end{matrix} \qquad ( 4 )$$

Notice that different coding rates, potential stream switching, and packet loss could result in a sequence that is not exactly the same as the single rate stream that is stored at the server.

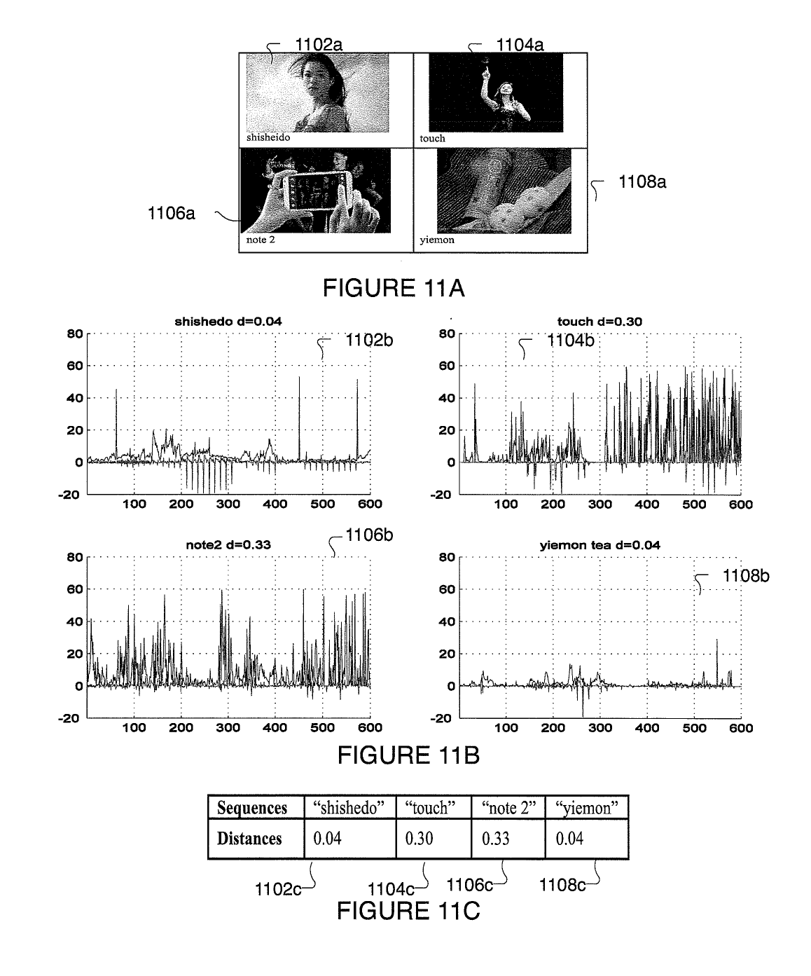

FIGS. 11A through 11C illustrate example forced playout content sequences according to this disclosure. The sequences includes images 1102a-1108a, charts 1102b-1108b, and differences 1102c-1108c. In some embodiments, these sequences may operate based on data recorded in the networked system 200.

Differential Eigen thumbnail appearances are plotted in the charts 1102b-1108b. Forced playout content sequences may be dynamic, with many scene cuts and actions, reflected by the three sequences denoted “shishedo”, “touch”, and “note 2.” The fourth sequence, denoted “yiemon,” is less dynamic content and more similar to regular programs as indicated by its differential traces. The average differences between the original sequences coded at 1 mbps and their 400 kpbs-coded alternative streams are average differences, and the average differences are summarized in differences 1102c-1108c. The differences 1102c-1108c are small compared with the dynamic range of the differential trace, which points to a high signal to noise ratio (SNR) of signature to coding variations. The thumbnail Eigen appearance modeling process has de-noising effects that can smooth out these differences and still offer robust verification performance.

In some embodiments, to improve performance, a noise suppression scheme may be applied at the differential Eigen appearance computing phase. A maximum difference threshold can be applied. In other words, if dx(k)>dₘₐₓ, then dx(k) is set to the value dₘₐₓ. The resulting signature is only 1-dimensional and can be quantized at eight bits per frame sample.

To verify the effectiveness of the proposed lightweight video fingerprinting system in playback verification, a test data set can be collected from various sources and include mostly commercial videos and movie trailers. There could be n=4000 video clips of a maximum length t=60 s in total. The test data set videos could all be 720×480 pixel resolution videos and coded at three rates, namely R=[480 kbps, 640 kbps, 800 kbps].

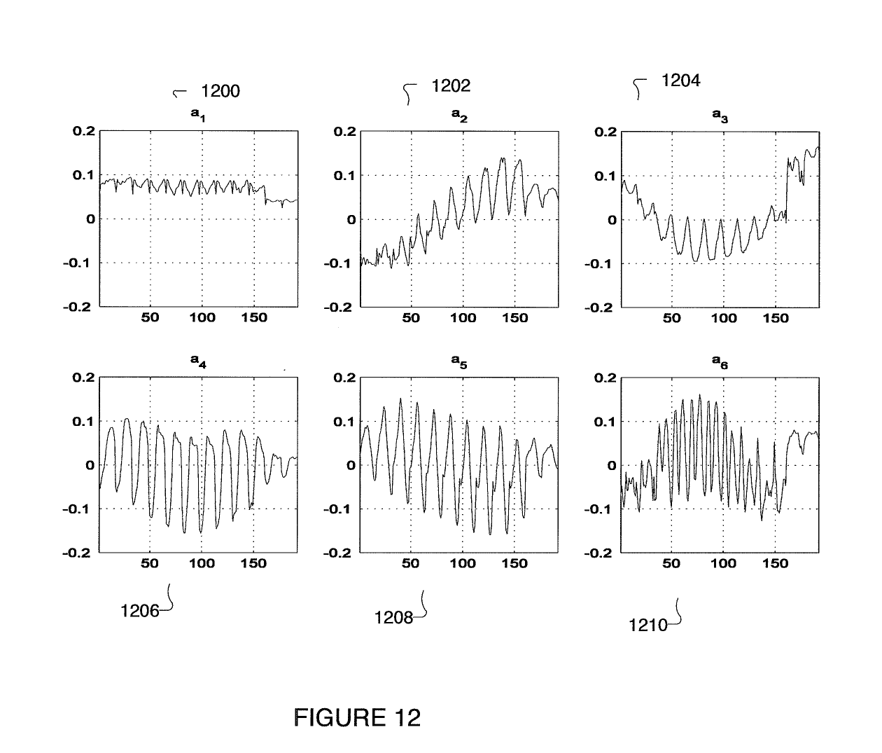

FIG. 12 illustrates example charts 1200-1210 of thumbnail Eigen appearance basis functions according to this disclosure. In some embodiments, the charts 1200-1210 may represent charts of data recorded in the networked system 200. To compute differential signatures, a thumbnail size of [w=16, h=12] is chosen, and the dimension of the Eigen appearance space is set as kd=6. The choice of dimensionality in computing the differential reflects a trade-off between signature resolution and robustness to transcoding.

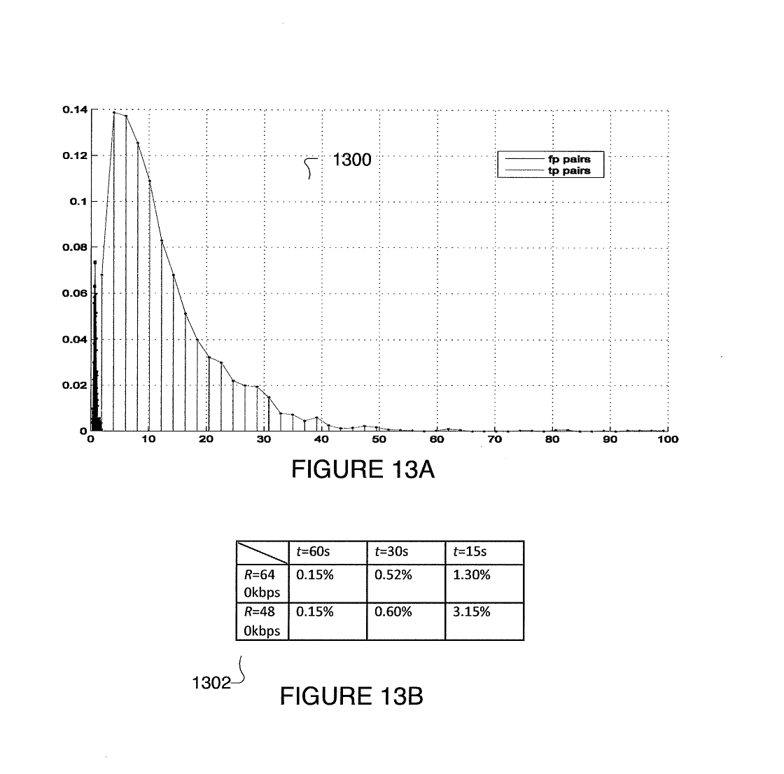

FIGS. 13A and 13B illustrate an example chart 1300 of thumbnail Eigen appearance basis functions and an example chart 1302 of false positive rates according to this disclosure. In some embodiments, the chart 1300 may be a chart of data recorded in the networked system 200. Positive probe tests can be conducted by computing 1−d differential signatures of test data that is set at lower bit rates, such as 640 kbps and 480 kbps, and computing their distance from original signatures extracted from 800 kbps video. The false positive probe tests can be conducted by randomly selecting m=10 clips from a distractor data set and computing their differential signatures and distances to the differential signature of the test data set. The distance histograms for true positive and true negative pairs are plotted in FIG. 13A.

The false positive pair distances are distributed over a wide range, with a mean of 12.37 and a standard deviation of 9.89. The true positive pair distances are tightly distributed around a mean of 0.77 and a standard deviation of only 0.25. In some embodiments, a distance threshold θ is applied to include a 100% true positive rate and the resulting false positive rates. In other words, the number of times that a bogus signature is mistaken for a true played back sequence are shown in the chart 1302 for test video clips of length t=[60, 30, 15] seconds. It is noted that as video clips become shorter, the false positive rates go up. However, for typical commercials of 30 seconds or more, the accuracy is good—at no false negatives in verification, the false positive rate is less than 1%.

The computational cost of computing the differential signature is small, such as by accounting for less than 0.5% of the total complexity of an FFMPEG decoding process. The communication overhead could be approximately eight bits per frame, which is approximately 200 bps for a typical 25 fps video regardless of its bit rate and frame size.

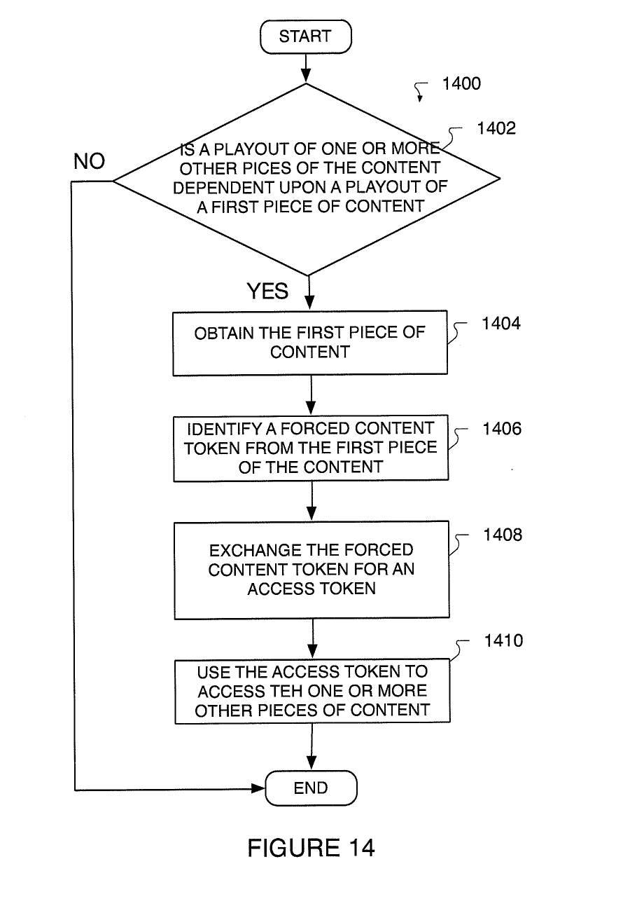

FIG. 14 illustrates another example method 1400 for retrieving content according to this disclosure. In some embodiments, the method 1400 may be implemented in the networked system 200.

In operation 1402, a client determines if a playout of one or more pieces of content is dependent upon a playout of a first piece of content. In operation 1404, if the one or more pieces of content are dependent upon the playout of the first piece of content, the client obtains the first piece of content.

In operation 1406, the client identifies a forced content token from the first piece of content. In operation 1408, the client exchanges the forced content token with the content server for an access token. In operation 1410, the client uses the access token to access the one or more pieces of the content.

Although the figures above have shown various systems, devices, and methods for retrieving content, various changes can be made to these figures without departing from the scope of this disclosure. For example, this disclosure is not limited to use with any particular file formats or network configurations. Also, while the steps of each method shown in the figures may include steps performed serially, various steps in each figure could overlap, occur in parallel, occur in a different order, or occur any number of times.

In some embodiments, various functions described above can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for obtaining content comprising:
determining that a playout of one or more other pieces of content is dependent upon a playout of a first piece of content;
obtaining the first piece of content;
identifying a forced content token associated with the first piece of content;
obtaining an access token using the forced content token; and
using the access token to obtain the one or more other pieces of content.

2. The method of claim 1, wherein an indication that the playout of the one or more other pieces of content is dependent upon the playout of the first piece of content is received in a media presentation description (MPD) file.

3. The method of claim 1, wherein the forced content token is identified as a hash of the first piece of content.

4. The method of claim 1, wherein the forced content token is identified as a watermark extracted from the first piece of content.

5. The method of claim 1, wherein obtaining the access token comprises:
sending the forced content token to a server using Hypertext Transmission Protocol (HTTP).

6. The method of claim 5, wherein obtaining the access token further comprises:
receiving the access token in an HTTP response.

7. The method of claim 1, wherein the access token is associated with a time period in which the access token is valid.

8. The method of claim 1, wherein using the access token to obtain the one or more other pieces of content comprises:
sending the access token in a Hypertext Transmission Protocol (HTTP) request to a content server.

9. The method of claim 8, further comprising:
receiving a redirection to a uniform resource locator (URL) of the one or more other pieces of content.

10. The method of claim 8, further comprising:
receiving the one or more other pieces of content in an HTTP reply.

11. The method of claim 1, wherein the forced content token comprises a fingerprint token.

12. The method of claim 11, wherein identifying the forced content token comprises:
creating a thumbnail for each of one or more frames in the first piece of content; and
calculating a differential trace signature for each of the one or more frames.

13. The method of claim 12, further comprising:
responsive to the differential trace signature being greater than a threshold for a frame, setting the differential trace signature for that frame to the threshold.

14. An apparatus configured to obtain content over a network, the apparatus comprising:
at least one memory configured to store a first piece of content and one or more other pieces of content; and
at least one processing device configured to:
determine that a playout of the one or more other pieces of content is dependent upon a playout of the first piece of content;
obtain the first piece of content;
identify a forced content token associated with the first piece of content;
obtain an access token using the forced content token; and
use the access token to obtain the one or more other pieces of content.

15. The apparatus of claim 14, wherein the at least one processing device is configured to use an indication that the playout of the one or more other pieces of content is dependent upon the playout of the first piece of content in a media presentation description (MPD) file.

16. The apparatus of claim 14, wherein the at least one processing device is configured to identify the forced content token as a hash of the first piece of content.

17. The apparatus of claim 14, wherein the at least one processing device is configured to identify the forced content token as a watermark extracted from the first piece of content.

18. The apparatus of claim 14, wherein the at least one processing device is configured to identify the forced content token by:
creating a thumbnail for each of one or more frames in the first piece of content; and
calculating a differential trace signature for each of the one or more frames.

19. The apparatus of claim 18, wherein the at least one processing device is further configured, responsive to the differential trace signature being greater than a threshold for a frame, to set the differential trace signature for that frame to the threshold.

20. A non-transitory computer readable medium embodying a computer program, the computer program comprising computer readable program code for:
determining that a playout of one or more other pieces of content is dependent upon a playout of a first piece of content;
obtaining the first piece of content;
identifying a forced content token associated with the first piece of content;
obtaining an access token using the forced content token; and
using the access token to obtain the one or more other pieces of content.
